(19) United States
(12) Patent Application Publication
(10) Pub. No.: US 2015/0189857 A1
(43) Pub. Date: Jul. 9, 2015

(54) Pet Shower

(71) Applicant: Irakli Qirjazi, Peabody, MA (US)

(72) Inventor: Irakli Qirjazi, Peabody, MA (US)

(21) Appl. No.: 14/150,218

(22) Filed: Jan. 8, 2014

(51) Int. Cl. A01K 13/00

(52) U.S. Cl. CPC A01K 13/001

(57) ABSTRACT

A shower includes a housing, having front and rear openings, suitable for use in washing a pet. An array of water jets coupled with the housing direct water towards an interior of the housing and an array of air vents coupled with the housing direct air towards an interior of the housing. A front gate is configured to at least partially close the front opening, while a rear door is configured to at least partially close the rear opening.

### BACKGROUND

Pets, in particular pets that spend time outside the home, are susceptible to soiling and absorbing offensive odors. Such pets frequently require bathing by their owners or other pet handlers who may use a home bathtub or an outdoor residential hose. These techniques present a variety of difficulties.

### SUMMARY

The general purpose of the present pet shower is to facilitate convenient washing and drying of a pet within a single enclosure in a manner avoiding the difficulties of known techniques. A shower suitable for use with a pet includes a housing having front and rear openings. An array of water jets is coupled with the housing so as to direct water towards an interior of the housing. An array of air vents is coupled with the housing so as to direct air towards an interior of the housing. A front gate is configured to at least partially close the front opening while a rear door is configured to at least partially close the rear opening.

### BRIEF DESCRIPTION OF THE FIGURES

FIG. 1 illustrates an isometric view of an example of a pet shower.

FIG. 2 illustrates a back view of the pet shower of FIG. 1.

FIG. 3 illustrates a front view of the pet shower of FIGS. 1 & 2.

FIG. 4 illustrates a detail view along line 4-4 of an example of an array of water jets usable with the pet shower of FIGS. 1-3.

FIG. 5 illustrates a detail view along line 5-5 of an example of an array of air vents usable with the pet shower of FIGS. 1-3.

FIG. 6 illustrates a side view of the pet shower of FIGS. 1 & 2 showing a fan.

### DETAILED DESCRIPTION

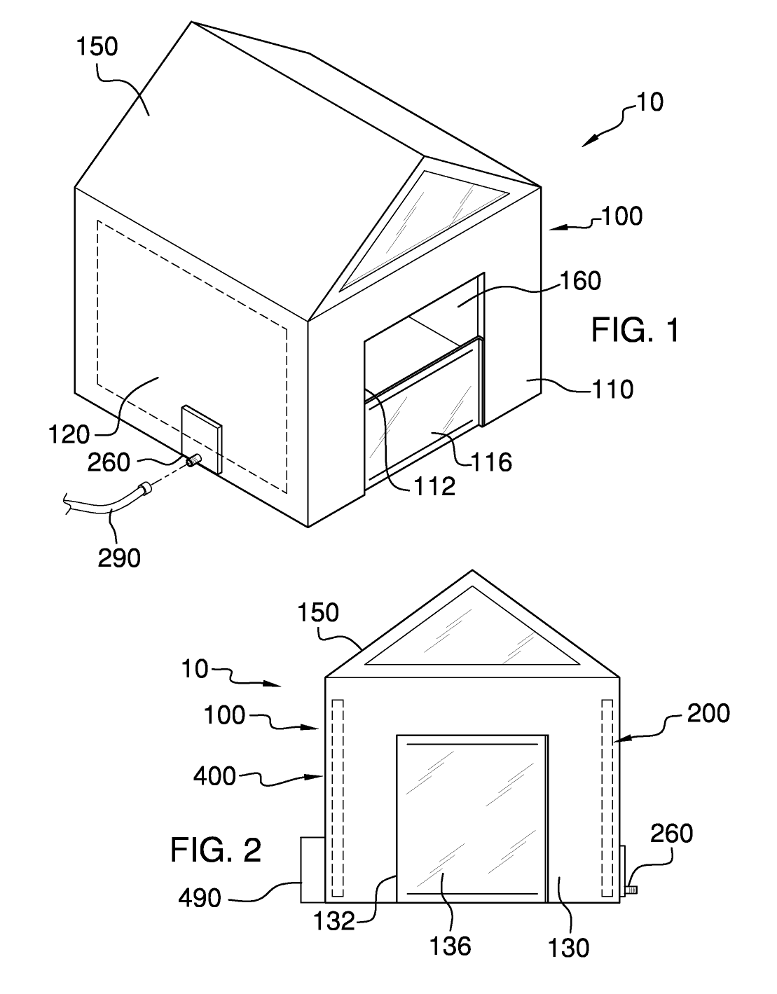

With reference now to the Figures, and in particular to FIGS. 1-5, a new shower generally designated by the reference numeral 10 will be described.

A pet wash or shower 10 includes a housing 100 having a number of walls 110, 120, 130 and 140 and a roof 150 surrounding an interior 160. A front opening 112 is formed in front wall 110 and a rear opening 132 is formed in rear wall 130. Housing 100 may take any of a variety of shapes including but not limited to the shape of a rectangular prism, a circular cylinder or a parallelepiped and may be provided in any of a variety of sizes conducive to substantially enclosing a pet.

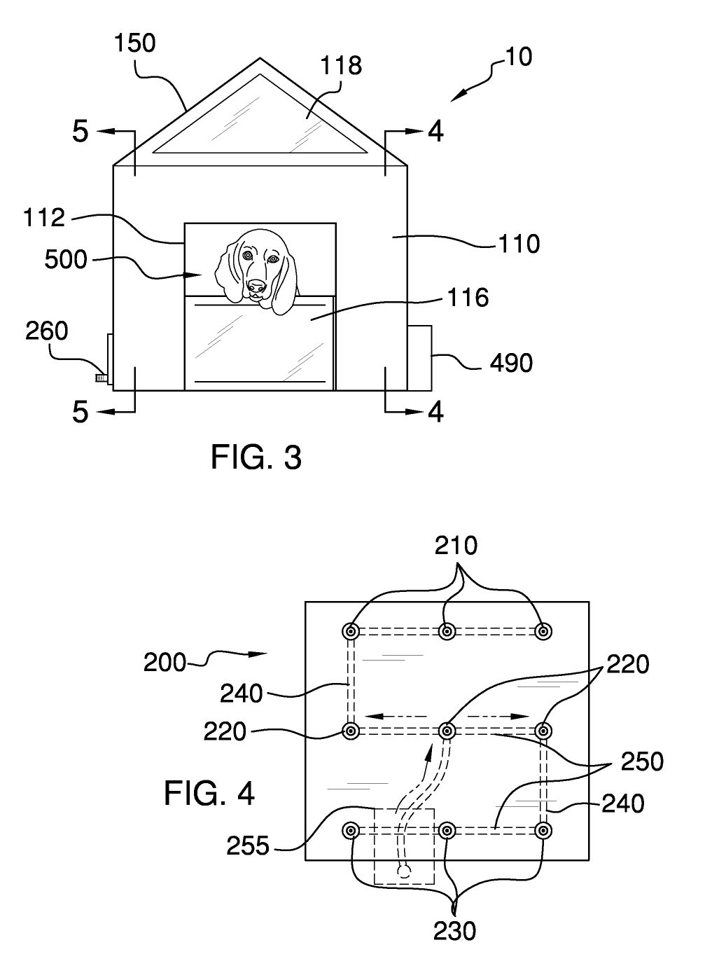

Roof 150 may include a contour or may be flat. In examples including a roof contour, one or more gables 118 (FIG. 3) may also be provided.

A front gate 116 is configured to at least partially close front opening 112 at a bottom portion and a rear door 136 is configured to at least partially close rear opening 132. In some examples, door 136 may completely close rear opening 132 and front gate 116 may take the form of a full door completely closing front opening 112.

Closure of the front 112 and rear 132 openings with front gate 116 and rear door 136, respectively, may be selectable such that an entity or object may pass through front 112 and rear 132 openings and then be secured within the interior 160 of housing 100. In some examples (not illustrated), front gate 116 and rear door 136 may be coupled with housing 100 by any of a variety of hinges while in other examples, they may be completely removable.

Housing 100 may be constructed from any of a variety of lightweight, durable, moisture-resistant materials including but not limited to plastics, papers, wood or a combination of these.

In some examples, one or both of rear door 136 and front gate 116 are formed from reduced opacity materials such that they are translucent or transparent.

In some examples, gables 118 may additionally or alternatively be formed from reduced opacity materials such that they are translucent or transparent.

An array 200 of water jets 210, 220, 230 may be coupled with housing 100 to direct water towards the housing 100 interior 160. The array 200 of water jets is interconnected by a plurality of pipes 240 and 250 in any of a variety of configurations conducive to thoroughly wetting an entity or object placed within the housing 100 interior 160. In one example configuration, water jets 210 of array 200 are interconnected in series with each other while water jets 230 of array 200 are interconnected in parallel with water jets 210. The array 200 of water jets is operatively coupled to a water inlet 260 configured for attachment to a water source 290. A motor 255 may be provided for pressurizing water between the water inlet 260 and water jets 210, 220 and 230.

The array 200 of water jets may be comprised of any number of water jets conducive to thoroughly wetting an entity or object placed within the housing 100 interior 160. As examples, array 200 may comprise three individual jets, nine individual jets or more than these.

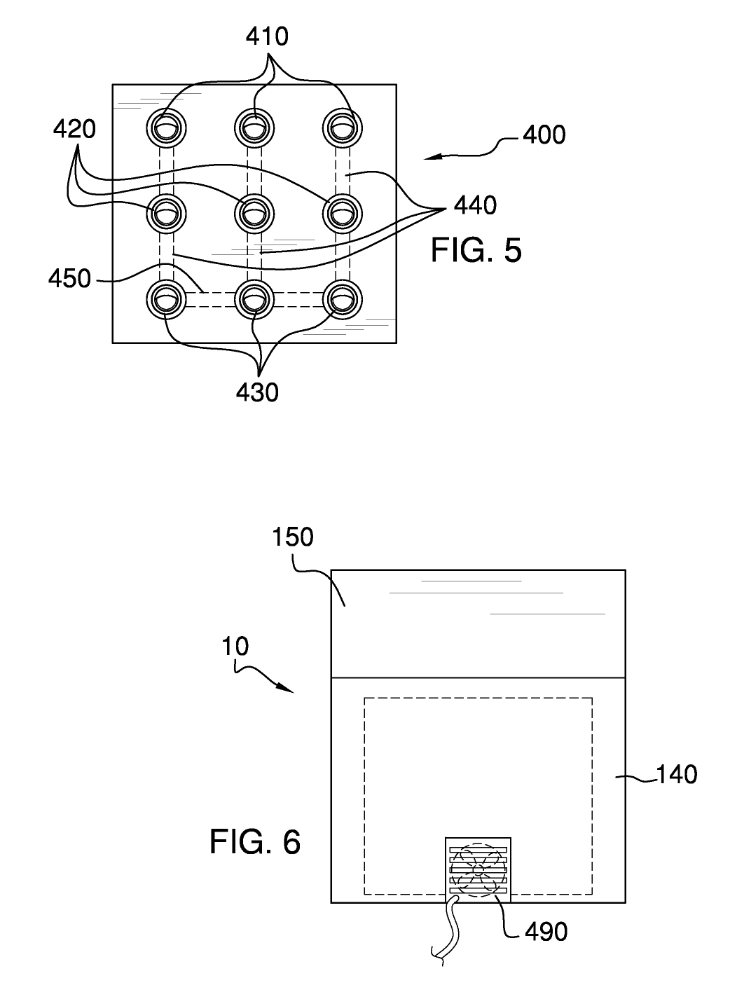

An array 400 of air vents 410, 420 and 430 may be coupled with housing 100 to direct air towards the interior 160 of housing 100. The array 400 of air vents is interconnected by a plurality of ducts 440 and 450 in any of a variety of configurations conducive to thoroughly drying an entity or object placed within the housing 100 interior 160. In one example configuration, air vents 410, 420, and 430 of array 400 are interconnected in series through ducts 440 (FIG. 5) while air vents 410 of array 400 are interconnected in parallel through duct 450 (FIG. 5). A portion of array 400 is configured for coupling with an air source. A motorized fan 490 is provided to drive air from an exterior of housing 100 through air vents 410, 420 and 430.

The array 400 of air vents may be comprised of any number of air vents conducive to thoroughly drying an entity or object placed within the housing 100 interior 160. As examples, array 400 may comprise three individual vents, nine individual vents or more that these.

In some examples, array 200 of water jets is arranged on a first side 120 of housing 100 between front 112 and rear 132 openings while array 400 of air vents is arranged between front 112 and rear 132 openings on a side 140 of housing 100 opposite the first side. However, other arrangements may be used, as desired.

In an example method, to bathe or otherwise wash a pet such as a dog, cat, horse, etc., a user provides shower 10 in an erect arrangement with water jet array 200 coupled with a water source 290 and air vent array 400 coupled with a fan or air source. With rear door 136 open, a pet 500 may be coaxed through rear opening 132 into the interior 160 of housing 100 and rear door 136 may be closed behind pet 500. With front gate 116 in a closed position, a portion of pet 500 such as the head may protrude through front opening 112.

With pet 500 within the interior 160 of housing 100, water may be provided from source 290 through array 200 and onto pet 500. Soap or other detergent may be applied to the now wet pet 500 either independent from the water or mixed into the water.

After washing and rinsing pet 500, air vent array 400 may be operated to blow air onto pet 500 to affect drying thereof. Once drying has been completed to the satisfaction of the pet 500 and the pet handler, front gate 116 may be opened to allow pet 500 to exit housing 100 and shower 10.

While the disclosure has been presented with respect to certain specific embodiments, it will be appreciated that many modifications and changes may be made by those skilled in the art without departing from the spirit and scope of the invention. It is intended, therefore, by the appended claims to cover all such modifications and changes as fall within the true spirit and scope of the invention.

What is claimed is:

1. A shower, comprising:
a housing including front and rear openings;
an array of water jets arranged on a first side of the housing between the front and rear openings;
a front gate configured to at least partially close the front opening; and
a rear door configured to at least partially close the rear opening.

2. The shower as set forth in claim 1 further comprising an array of air vents arranged on a side of the housing opposite the first side.

3. The shower as set forth in claim 2 wherein the front gate is comprised of a material having a low opacity.

4. The shower as set forth in claim 3 wherein the rear door is comprised of a material having a low opacity.

5. A shower, comprising:
a housing including front and rear openings, wherein the housing is configured to house a pet;
an array of water jets coupled together within the housing;
an array of air vents coupled together within the housing;
a front gate configured to at least partially close the front opening; and
a rear door configured to at least partially close the rear opening.

6. The shower set forth in claim 5 wherein the front gate is configured to close a bottom portion of the front opening while leaving a top portion of the front opening unobstructed.

7. The shower set forth in claim 5 wherein the array of water jets is arranged on a first side of the housing between the front and rear openings.

8. The shower set forth in claim 5 wherein the array of air vents is arranged between the front and rear openings on a side of the housing opposite the first side.

9. The shower set forth in claim 5 wherein the array of water jets is configured to direct water towards an interior of the housing.

10. The shower set forth in claim 5 wherein the array of air vents is configured to direct air towards an interior of the housing.

11. The shower set forth in claim 5 wherein the array of air vents is configured for coupling with an air source.

12. The shower as set forth in claim 5 further comprising a motor for pressurizing water between the water inlet and the water jets.

13. The shower set forth in claim 5 wherein the array of air vents is interconnected by a plurality of ducts.

14. The shower set forth in claim 5 wherein the array of water jets is interconnected by a plurality of pipes.

15. The shower set forth in claim 5 further comprising a fan configured to drive air from an exterior of the housing through the air vents.

16. The shower set forth in claim 5 wherein the array of water jets is operatively coupled to a water inlet configured for attachment to a water source.

17. The shower set forth in claim 16 further comprising a motor for pressurizing water between the water inlet and the water jets.

18. A pet shower comprising:
a housing comprised of a lightweight, durable material and configured to house a pet, the housing having a front opening, a rear opening, an interior, and a first side;
a plurality of fluidly interconnected pipes disposed within the housing on the first side;
an array of water jets fluidly interconnected by the pipes, the water jets configured to direct water towards the housing interior;
a plurality of interconnected air ducts disposed within the housing on a side of the housing opposite the first side;
an array of air vents interconnected by a plurality of ducts, the air vents configured to direct air towards an interior of the housing;
a front gate of the housing, the front gate configured to selectively close a bottom portion of the front opening while leaving a top portion of the front opening unobstructed;
a rear door of the housing, the rear door configured to at least partially selectively close the rear opening;
a motor disposed within the housing, the motor in operational communication with the water inlet and water jets, the motor configured to pressurize water between the water inlet and the water jets; and
a motorized fan disposed within the housing, the fan configured to drive air from an exterior of the housing through the air vents.
